(19) United States
(12) Patent Application Publication
(10) Pub. No.: US 2014/0151377 A1
(43) Pub. Date: Jun. 5, 2014

(54) DRUM LINER AND METHOD OF MANUFACTURING SAME

(71) Applicant: GRAYLING INDUSTRIES, INC., Alpharetta, GA (US)

(72) Inventors: Kurt D. Ross, El Paso, TX (US); Randy Ray Sullinger, Columbia, MO (US)

(73) Assignee: GRAYLING INDUSTRIES, INC., Alpharetta, GA (US)

(21) Appl. No.: 13/693,924

(22) Filed: Dec. 4, 2012

(51) Int. Cl. B65D 90/04; B31B 29/60

(52) U.S. Cl. CPC B65D 90/046; B31B 29/60
USPC 220/495.05; 493/189

(57) ABSTRACT

A drum liner (10) is disclosed which is configured to be used with a drum (11) having a side wall (14) terminating with a top edge (15), a removable lid (16) having a lip (19), and crimp ring (17). The liner has a bottom wall (24), a top rim (25), and a cylindrical side wall (26) made of flexible material. The liner side wall has an exterior surface (27) and an interior surface (28). The liner top rim has a positioning flange (29) extending to an attachment lip (30) configured to fit about the drum top edge and within the drum lid lip. The liner side wall is heat sealed to the top rim positioning flange. The bottom wall is also heat sealed to the bottom margin of the liner side wall.

### TECHNICAL FIELD

This invention relates to liners used in conjunction with drums and to a method of manufacturing a liner.

### BACKGROUND OF THE INVENTION

Cylindrical drums have oftentimes been used to ship large quantities of liquid or granular products. These drums are typically made from metal and contain a volume of approximately 55-gallons. Depending upon the shipping contents of the drum and other shipping related factors, they may be used once or may be reused multiple times. If the drum is utilized multiple times, they are usually cleaned between uses.

The cleaning process of a drum may be tedious and time consuming. As such, drum liners have been designed to be inserted into a drum to form a barrier between the shipping contents and the drum itself. Once the contents of the drum are expelled from the liner, the liner is removed and disposed.

In the past, these drum liners have been in the form of a large bag having a narrow neck configured to mate or pass through the small opening or boss in the top wall of the drum. Thus, the liner has a relatively small inlet or outlet, thereby limiting the filling (ingress) or subsequent removing (egress) of the contents from the liner. Additionally, the flexible liner material may easily clog or partially block this small opening.

Another problem associated with these liners is the proper placement of the liner within the drum. As the liner is typically made of a thin, flexible plastic material, it is sometimes difficult to conform the liner to the outer drum. The improper conforming of the liner may result in the liner have crease lines or folds which can block the flow of contents, reduce the capacity of the liner, or create a weakness in the liner. This problem is especially prevalent in the bottom area, which is also the most inaccessible to a person mounting, installing or utilizing the liner.

Accordingly, it is seen that a need remains for a liner that can be more efficiently mounted, inserted or installed into a drum while also providing better ingress and egress of the contents. It is to the provision of such therefore that the present invention is primarily directed.

### SUMMARY OF THE INVENTION

A liner for use with a drum having side walls terminating at a top edge comprises a bottom wall, a top having at least a peripheral rim having a capturing or attachment lip configured to conform to the drum top edge and a mounting or positioning flange extending from the lip, and a side wall made of a flexible material and having a bottom margin coupled to the bottom wall and a top margin coupled to the peripheral rim positioning flange.

### BRIEF DESCRIPTION OF THE DRAWING

FIG. 1 is a perspective, partially exploded view of a drum liner embodying principles of the invention in a preferred form, shown in conjunction with a drum.

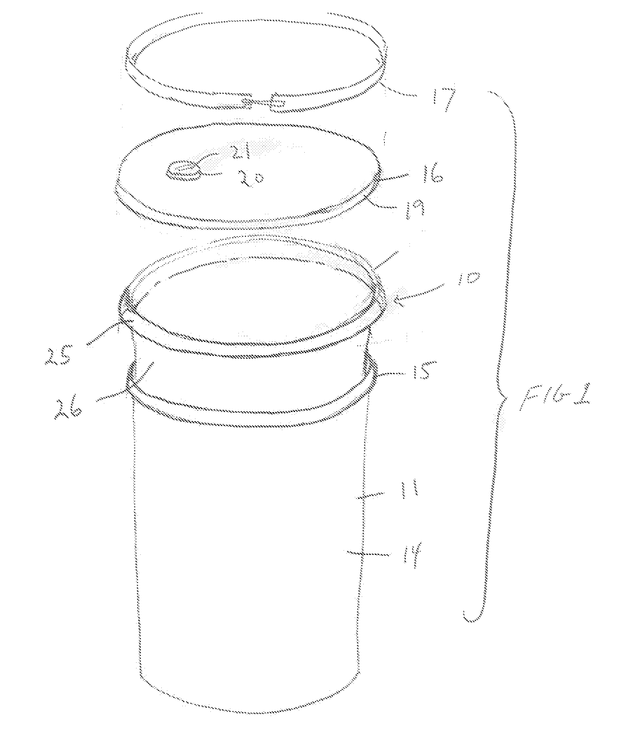

FIG. 2 is a perspective view of a the drum liner and drum of FIG. 1.

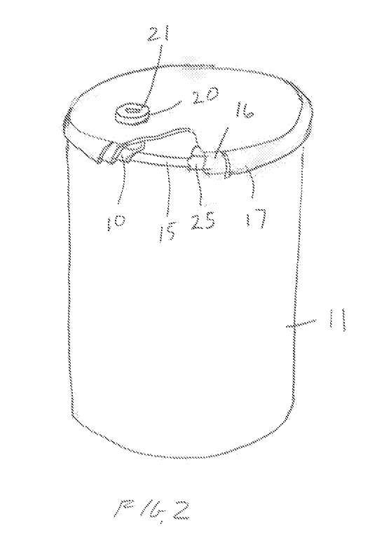

FIG. 3 is a cross-sectional view of a portion of the drum liner of FIG. 1.

### DETAILED DESCRIPTION

With reference next to the drawings, there is shown a drum liner 10 embodying principles of the invention in a preferred form. The liner 10 is configured to be used in conjunction with a conventional drum 11, which is preferably in the form of a rigid, metal, fiber, or plastic, 55-gallon drum.

The drum 11 has a bottom wall 13, a generally cylindrical side wall 14 terminating with a rolled or enlarged top edge 15, and a removable cap, top wall or lid 16. The drum 11 also includes a compression or crimp ring 17 that is designed to fit about the lid 16 and drum enlarged top edge 15 and secure it in place through its compression, which is typically achieved by having the crimp ring split with a camming lever or threaded adjuster coupled to the split ends of the crimp ring to bring the ends closer together when it is mounted in place. The lid 16 has a rounded peripheral lip 19 configured to capture at least a top portion of the top edge 15 of the drum. The lid 16 may include a fitting, fitment or boss 20 having a removable closing plug 21 which allows access to the interior of the drum and liner.

The liner 10 has a bottom wall 24, an annular, peripheral top rim 25 and a cylindrical side wall 26 extending between the bottom wall 24 and top rim 25, so as to define a generally closed bottom, open top, cylindrical shaped configuration. The liner side wall 26 has an exterior surface 27, an interior surface 28, and preferably a uniform thickness to prevent the formations of weak spots. The liner side wall 26 may be made of a flexible plastic sheet, foil laminated material, or other film material such as a polyethylene film having a thickness of 2 to 20 mils. The bottom wall 24 and top rim 25 may also be a polyethylene material having a thickness of 2 to 40 mils, the top rim 25 being thermoformed to retain its shape.

The liner top rim 25 has a mounting or positioning flange 29 extending outwardly to a rounded edge capturing or attachment lip 30 configured to fit snugly about at least a top portion of the top edge 15 of the drum and within the rounded peripheral lip 19 of the drum lid 16. The liner side wall 26 is mounted to the inwardly facing surface of the top rim positioning flange 29. It should be understood that as an alternative, the interior surface 28 of the line side wall 26 may be mounted or attached to the outwardly facing surface of the positioning flange 29.

The liner may be constructed by forming a plastic film tube which is cut to length to form the liner side wall 26. The liner top rim 25 is then attached to the top edge or margin of the tubular side wall by heat sealing the exterior surface 27 to the inwardly facing surface of the top rim positioning flange 29. The bottom wall 24 is also attached to the side wall 26 by heat sealing the inwardly facing surface of the bottom wall 24 to the exterior surface 27 of the bottom margin of the side wall 26.

In use, the liner 10 is simply placed within a corresponding drum 11 with the liner to rim attachment lip 30 fitted over the top edge 15 of the drum. The attachment lip 30 is intended to maintain the liner in position during the filling process.

The content material may be placed into the combination drum and drum liner in two different manners. In the first manner, the drum lid 16 is placed on top of the drum with the drum lid rounded lip 19 overlaying the liner top rim attachment lip 30. The crimp ring 17 is then placed about the drum lid rounded lip 19 and rounded top edge 15 and tightened to secure the drum lid in place. Content material may then be poured through the drum lid boss 20 and sealed with plug 21. In the second manner, the liner is placed in position and the content material is poured directly into the open top end of the liner. The drum lid 16 is then placed in position and secured with the crimp ring 17, as previously described.

Once the drum is shipped and the material content is subsequently extracted from the drum liner, the crimp ring 17 and drum lid are removed. The drum liner 10 is then removed from the drum, leaving an essentially clean drum which is ready for re-use.

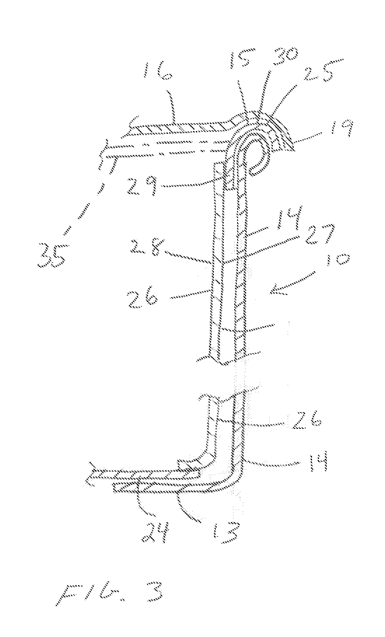

It should be understood that as an alternative, the liner may have a complete or full top rather than merely the annular rim 25 shown in the preferred embodiment, the full top being partially shown by the phantom lines in FIG. 3. The full top would include a central plate 35 spanning the rim to produce a completely sealed or closed liner having a sealable fitment in the top through which passes the content material.

It should also be understood that the liner bottom 24 and rim 25 being formed separately from the side wall 26 enables them to be made of different materials and/or of different thicknesses. As such, the bottom 24 may be made thicker or thinner and of material having different physical characteristics depending on the type of content material being placed therein. Preferably, the top rim 25 and bottom wall 24 are made of a material which is stiffer than the material of the side walls 26 to provide better support of the drum liner.

It thus is seen that a drum liner is now provided which overcomes problems associated with liners of the prior art. While this invention has been described in detail with particular references to the preferred embodiments thereof, it should be understood that many modifications, additions and deletions, in addition to those expressly recited, may be made thereto without departure from the spirit and scope of the invention.

1. A liner for use with a drum having side walls terminating at a top edge, said liner comprising,
a bottom wall;
a top having at least a peripheral rim having an attachment lip configured to capture to the drum top edge and a positioning flange extending from said lip, and
a side wall made of a flexible material, said side wall having a bottom margin coupled to said bottom wall and a top margin coupled to said peripheral rim positioning flange.

2. The liner of claim 1 wherein said side wall bottom margin is coupled to an interior surface of said bottom wall.

3. The liner of claim 1 wherein said side wall top margin is coupled to an interior surface of said peripheral rim positioning flange.

4. The liner of claim 3 wherein said side wall bottom margin is coupled to an interior surface of said bottom wall.

5. The liner of claim 1 wherein said bottom wall is made of a material which is stiffer than said side wall flexible material.

6. The liner of claim 1 wherein said top wall includes a center plate spanning said peripheral rim.

7. The liner of claim 1 wherein said peripheral rim is made of a material which is stiffer than said side wall flexible material.

8. A combination drum and drum liner comprising,
a drum having a side wall with a top edge, and
a drum liner having a bottom wall, a side wail coupled to said bottom wall, and a peripheral rim coupled to said side wall, said peripheral rim having an attachment lip sized and shaped to attach said top edge of said drum, said peripheral rim also having a positioning flange coupled to said attachment lip and to said side wall.

9. The combination drum and drum liner of claim 8 wherein said side wall bottom margin is coupled to an interior surface of said bottom wall.

10. The combination drum and drum liner of claim 8 wherein said side wall top margin is coupled to an interior surface of said peripheral rim positioning flange.

11. The combination drum and drum liner of claim 10 wherein said side wall bottom margin is coupled to an interior surface of said bottom wall.

12. The combination drum and drum liner of claim 8 wherein said bottom wall is made of a material which is stiffer than the material which forms said drum liner side wall.

13. The combination drum and drum liner of claim 8 wherein said top wall includes a center plate spanning said peripheral rim.

14. The combination drum and drum liner of claim 8 wherein said peripheral rim is made of a material which is stiffer than said side wall flexible material.

15. A method of manufacturing a drum liner comprising the steps of:
(a) providing a bottom wall;
(b) providing a tubular side wall made of a flexible material;
(c) providing a top wall having a peripheral rim with an attachment lip and a positioning flange, and
(d) heat sealing a top margin of the side wall to the positioning flange of the top wall.

16. The method of claim 15 further comprising step (e) heat sealing a bottom margin of the side wall to the bottom wall.

17. The method of claim 16 wherein the side wall bottom margin is coupled to an interior surface of the bottom wall.

18. The method of claim 15 wherein the side wall top margin is coupled to an interior surface of the positioning flange.

19. The method of claim 18 wherein said side wall bottom margin is coupled to an interior surface of said bottom wall.

20. The method of claim 15 wherein the bottom wall is made of a material which is stiffer than the side wall flexible material.

21. The method of claim 15 wherein the top wall includes a center plate spanning said peripheral rim.

22. The method of claim 15 wherein the top wall is made of a material which is stiffer than the side wall flexible material.
